(19) United States
(12) Patent Application Publication
(10) Pub. No.: US 2009/0063092 A1
(43) Pub. Date: Mar. 5, 2009

(54) Pin Array Locking Mechanism

(76) Inventors: Amber Mockler Pierce, Provo, UT (US); Kenneth John Mockler, Austin, TX (US); Jordan Jay Cox, Provo, UT (US)

Correspondence Address: STEVEN L. NICHOLS;RADER, FISHMAN & GRAUER PLLC, 10653 S. RIVER FRONT PARKWAY, SUITE 150, SOUTH JORDAN, UT, 84095, US

(21) Appl. No.: 11/846,799

(22) Filed: Aug. 29, 2007

(51) Int. Cl. G01B 5/20

(52) U.S. Cl. 702/167; 33/568

(57) ABSTRACT

A pin array includes a plurality of pins arranged in an array; and one or more flexible tubes in contact with each of the pins such that, when pressurized, each of the flexible tubes applies pressure to sides of the pins to prevent further movement of the pins. A method of locking a pin array that includes a plurality of pins arranged in an array; and one or more flexible vessels in contact with each of the pins, the method comprising controlling a pressure of a fluid in the flexible vessels to selectively allow or prevent movement of the pins with respect to the flexible vessels.

### BACKGROUND

Pin arrays consist of a large number of pins disposed in holes in a substrate or plate. Typically, the pins have a head at either end that prevents each pin from sliding entirely out of the hole in which it is placed and provides a smoother surface of the pin array. However, between the two heads, the pins can slide back and forth in the holes in which they are disposed to extend, up to the length of the pin, out of either side of the substrate along the axis of the pin.

Pin arrays have a variety of uses. In some applications, a shape or object is pressed into the field of pins on one side of the substrate, thereby pushing the pins through the substrate toward the opposite side of the substrate with a contour that matches the shape or object pressed into the field of pins. In this way, pin arrays have been used as toys, devices for making surface measurements or models of three-dimensional objects and rapid prototyping molds. Pin arrays have also been used to produce writing in Braille for blind or visually impaired individuals.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIGS. 1a and 1b show a top and side view, respectively, of an exemplary embodiment of a pin array, according to principles described herein.

FIG. 2 is perspective view of a section of a pin array, according to principles described herein.

FIG. 3 is perspective view of a section of a pin array, according to principles described herein.

FIGS. 4a, 4b, and 4c are cross-sectional diagrams of an exemplary pin locking mechanism, according to principles described herein.

FIG. 5 is a cross-sectional diagram of an exemplary pin array, according to principles described herein.

FIG. 6 is a cross-sectional diagram of an exemplary pin array, according to principles described herein.

FIG. 7 is a cross-sectional diagram of an exemplary pin array, according to principles described herein.

FIG. 8 is a cross-sectional diagram of an exemplary pin array, according to principles described herein.

FIG. 9 is a cross-sectional diagram of an exemplary pin array, according to principles described herein.

FIG. 10 is a cross-sectional diagram of an exemplary measurement system utilizing a pin array.

FIG. 11 is a flow chart illustrating an exemplary method for utilizing a pin array locking mechanism.

Throughout the drawings, identical reference numbers designate similar, but not necessarily identical, elements.

### DETAILED DESCRIPTION

One of the fundamental challenges of using pin arrays is selectively locking the pins in place to hold a desired shape for a period of time. For example, if the array is being used as a mold, the desired shape of the mold is imparted to the field of the pins. Then, the pins need to be locked in that position so that the mold can be used. Alternatively, if the pin array is being used to communicate in Braille, a Braille page is produced using the pin array. Then, the pins need to be locked in to that position so that the Braille can be read by a user.

In most such pin array applications, it is desirable that there be at least three distinct levels of locking force. At the conclusion of one cycle of use, the pin array is typically reset by moving all the pins to a uniformly extended position on one side of the substrate. During the resetting operation, it is desirable that there be minimal or no locking force on the pins, i.e. that the pins slide freely to the desired uniform position. Even a small amount of locking force on each pin would cause the resetting mechanism to exert a relatively large amount of force to reset a large number of pins at one time.

An intermediate amount of locking force is desired when making a surface measurement of a three dimensional object or using an actuator to move the pins into a particular desired configuration, such as a shape based on an electronic design or model, or a page of Braille. The intermediate locking force must be sufficient to prevent motion of the pins as a result of accidental acceleration or handling, but not so great that the pins mar the surface of the three dimensional object being imprinted or require excessive actuation force to properly position.

Once individual pins within the pin array have been moved to a desired position, the pin array should be firmly locked to prevent any further undesirable motion of the pins while the array is being used in that application. In surface measurement applications, it is critical that the pins remain securely in place until the pin displacement measurement has been completed. In tactile array applications, the pins must be locked to allow the blind or sight impaired individual to manually “read” the pin array by touching the pins with their fingers and/or palms. In molding applications, the pins must be even more firmly locked to resist the forces exerted as the molding medium is pressed against the pin array.

Consequently, the present specification describes a novel system and method for selectively locking a pin array once the pins have been positioned in a desired configuration. The system and method described herein further allows the user to selectively control the locking force exerted on the pins of the array so that the pins can be under little or no locking force during a reset, under an intermediate locking force while being relatively positioned, or under a firm locking force that prevents any motion of the pins while the array is being used in a particular configuration.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

As indicated above, ideally, the locking force applied to a pin array should be infinitely variable to accommodate use of the pin array in a wide variety of applications. Additionally, it is desirable that the pin locking mechanism be inexpensive, have minimal wear, and exert a uniform force on each pin throughout the array. Various pin array locking mechanisms have been proposed and/or used, including, shifting a center plate between two outer plates, a ribbon stretched in between the pins in a serpentine fashion, various forms of viscous fluids that contact the pins, various membranes such as foam or rubber that create friction as they contact the pins, and individual pin locking mechanisms.

Many of these locking devices do not apply uniform force to all the pins in the pin array. For example, the serpentine ribbon uses friction to prevent the pins from moving when the ribbon tension is increased. However, the friction between the ribbon and the pins prevents uniform tension along the length of the serpentine ribbon. The pins closest to the application of the tensioning force experience higher locking forces than the pins that are distant from the point that the tensioning force is applied to the ribbon.

Other locking mechanisms, such as a center plate sandwiched between two outer plates, require extreme precision to exert the same amount of force on each pin. In this style of locking mechanism, the top, center, and bottom plates have matching holes that allow the pins to pass through the entire assembly. The locking mechanism is actuated when the center plate is shifted, which pinches the pins as they pass through the now slightly offset holes. The holes in the center plate must be precisely drilled so that when the center plate is shifted it exerts a uniform shearing force on all pins in the pin array. Even small amounts of error or wear within specific holes will result in a large change in locking force across the pins of the array.

Locking accomplished by bringing viscous fluids and various membranes into contact with the pins typically provides only light locking forces and is susceptible to leakage, contamination, or wear. Individual pin locking mechanisms can be configured to apply uniform locking force to each pin, but are prohibitively expensive. Further, the individual pin locking mechanisms can take up significant space, leading to a lower pin density than could otherwise be achieved.

From the forgoing it is clear that there is a need for an inexpensive pin array locking mechanism that is configured to exert a variable amount of locking force. Further, the locking mechanism should be relatively immune to wear and exert uniform force on each pin within the pin array.

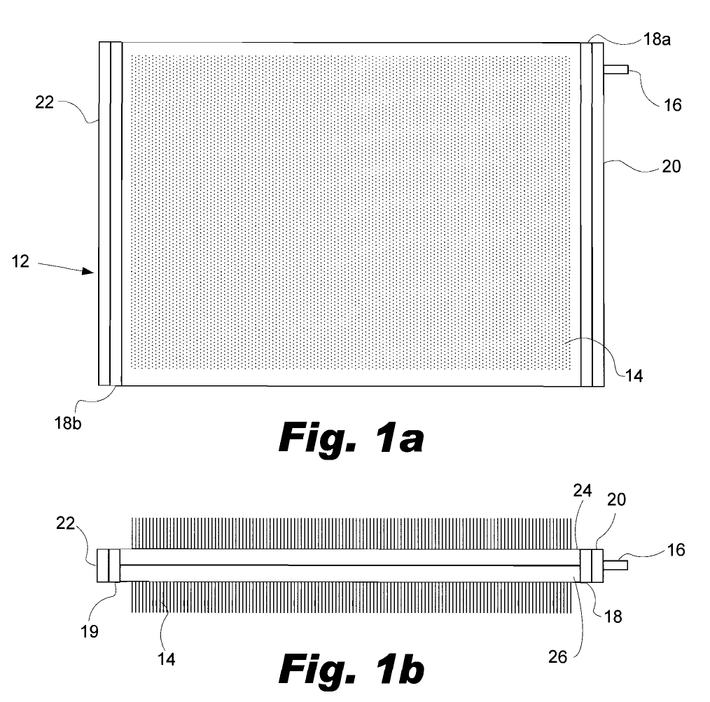

FIG. 1a shows a top view of an exemplary embodiment of a pin array (12). FIG. 1b shows a side view of the exemplary pin array (12). As shown in FIGS. 1a and 1b, the pins (14) are arranged in an array across the surface of the pin array (12).

However, rather than having a single substrate, a top plate (24) and a bottom plate (26) are provided which each contain a plurality of matching and registered holes through which the pins (14) extend. In this embodiment, the pin array (12) further comprises a fluid inlet port (16), manifold (20), first interface plate (18), second interface plate (19), and end plate (22). The function of these components of the pin array (12) will be described in detail below.

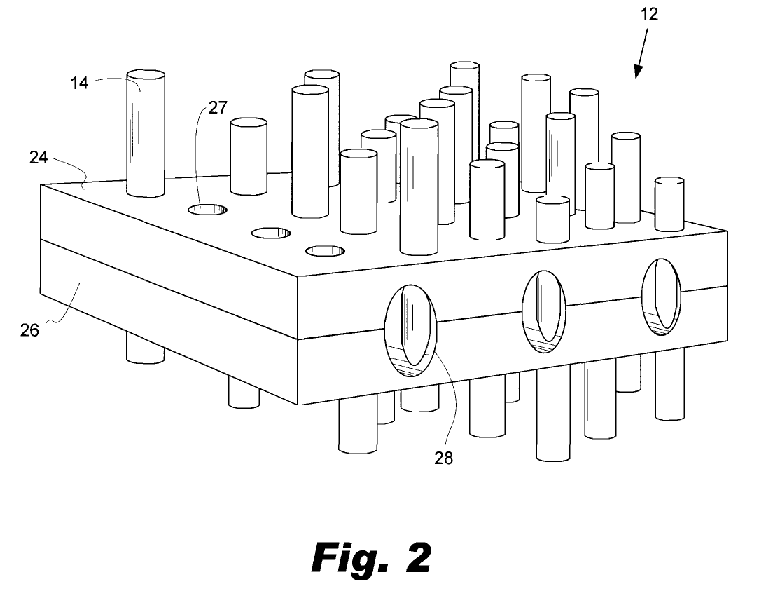

Now referring to FIG. 2, which shows a perspective view of one embodiment of a pin array (12). Pins (14) extend through holes (27) in top plate (24) and corresponding holes in the bottom plate (26). Grooves in the top plate (24) and corresponding grooves in the bottom plate (26) form channels (28). In this embodiment, the channels (28) extend across the width of the plates and are placed between every other row of pins (14). The holes (27) that accommodate the pins (14) partially intersect, ideally bisect, the channels (28). Thus, when the pins (14) are inserted through the plates, the sides of the pins (14) protrude into a channel (28). Because the channels (28) extend through the plates between every other row of pins (14), each pin (14) protrudes into a channel (28). Although this embodiment shows channels (28) that are formed by a combination of straight grooves within the top plate (24) and the bottom plate (26), it is understood that the channels (28) may be formed by a variety of methods and in various geometries.

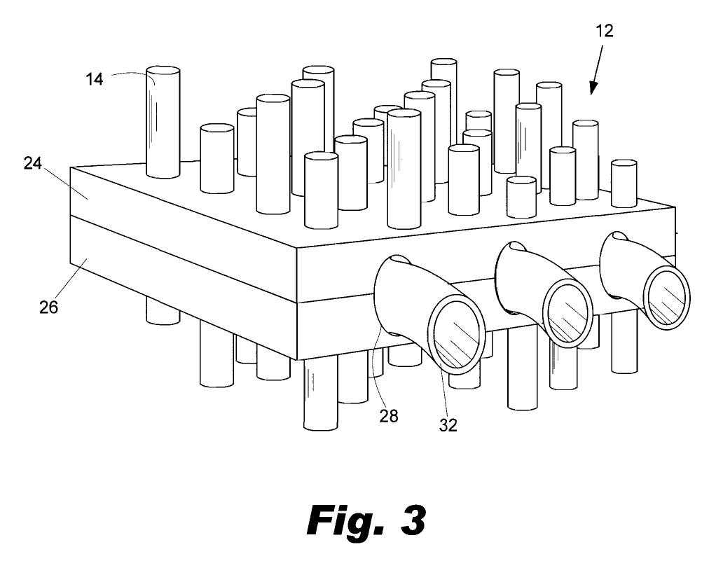

Now referring to FIG. 3, FIG. 3 shows a perspective view of an exemplary embodiment of a pin array (12). Similar to FIG. 2, pins (14) extend through holes in the top plate (24) and corresponding holes in the bottom plate (26), and grooves in the top plate (24) and corresponding grooves in the bottom plate (26) form a channel (28). Tubes (32) run through the length of each channel (28). In this embodiment of the invention, the tubes (32) are comprised of an elastic outer wall designed to contain a fluid within. The tubes (32) may be made from a wide variety of materials of varying levels of elasticity and in various geometries and cross sectional shapes. By way of example and not limitation, the tubing material could be latex. The fluid, as used in this context, may be a gas, liquid, or plastic solid. The tubes (32) expand when the fluid pressure is increased within the tube (32) and contract when the fluid pressure is decreased within the tube (32). Additionally, negative fluid pressure can be created within the tube (32). Negative fluid pressure refers to the condition in which the fluid within the tube (32) has a lower pressure than the ambient pressure outside the tube (32).

Because the pins (14) protrude into the channels (28), the outer surface of the tubes (32) can come into contact with each pin (14) of the pin array (12). The extent to which, and the pressure with which, the tube (32) contacts the pins (14) is determined by the amount of fluid pressure within the tube (32). The fluid pressure may be changed by various means that are well known to those of skill in the art of hydraulics or pneumatics, such as plungers, pumps, valves, attachment to pressure reservoirs, variation in volume, change in temperature, and the like.

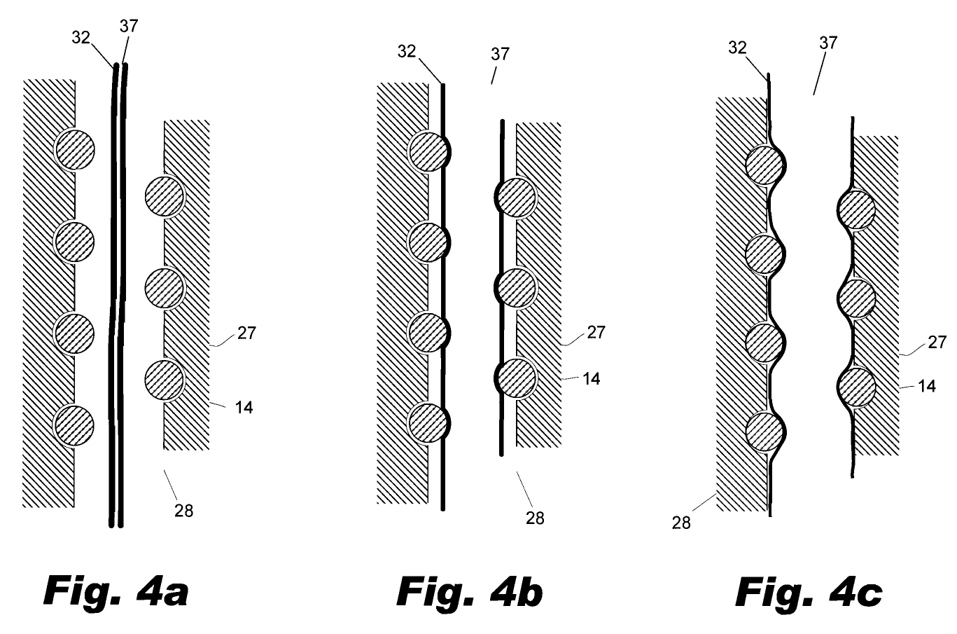

Now referring to FIGS. 4a, 4b, and 4c, various cross-sectional diagrams of a pin array (12, FIG. 3) are illustrated. FIG. 4a shows pins (14) extending through the top and bottom plates (24 and 26, respectively, FIG. 3) and protruding into a channel (28) between the plates (24 and 26). In FIG. 4a, the tube (32) contains a fluid (37) which has a lower fluid pressure than the ambient pressure surrounding the tube (32). This causes the tube (32) to collapse, reducing its cross-sectional area. Thus, the tube (32) has minimal contact with the pins (14). In one exemplary embodiment, the tubes are cut shorter than the final installed length, such that the elastic tube is in a stretched condition. When the fluid (37) is at ambient pressure with the tube (32) it is stretched and resting against the vertical pins. As the fluid pressure is lowered, the tube begins to collapse, first from the sides that are in contact with the pins. Once the tubes begin to collapse from the sides then each will continue until completely flat and vertical between the pins aided by the pre-stretching force at installation. Finally, with the stretched and vertically flattened tube in the middle of the channel there will be either zero contact between the tube and all pins or at most very lightly touching some pins with virtually zero force. In this embodiment, the distance between pins across the channel can be closer together than the outer diameter of the installed tube when the fluid pressure is at ambient and farther apart than the thickness of the flattened tube when the fluid pressure is low enough below ambient to completely collapse the tube. The advantage of these design dimensions of the pin spacing relative to the tube dimensions with the stretched tube is that the tube will provide low friction uniformly to every pin with ambient fluid pressure and the tube will collapse vertically flat and in a straight line between the pins with virtually no contact force on any pin when the fluid pressure is low enough below ambient to collapse the tube.

FIG. 4b illustrates the tube (32) cross-section when the working fluid pressure in the tube (32) is equal to the ambient or surrounding pressure. The tube (32) is in its relaxed state. In its relaxed state, the tube (32) lightly contacts the pins (14) and fills more of the channel (28).

In FIG. 4c, the pressure within tube (32) has been increased significantly and the tube (32) has expanded to substantially fill the channel (28). As a result, the pins (14) are pressed against the side of the holes (27) that the pins (14) pass through, creating significant and uniform friction between all of the pins in the array (14) and the wall of the holes (27). The maximum pressure that can be safely utilized within the tube (32) is not limited by the material strength of the walls that make up the tube (32), but by the strength of the channel (28) walls. Thus, extremely high pressures can be utilized within the tubes (32) without compromising the integrity of the tubes (32). Further, because the tube (32) encloses the fluid (37), the fluid (37) is prevented from leaking or escaping through the holes (27) that extend through the top plate (24, FIG. 3) and the bottom plate (26, FIG. 3).

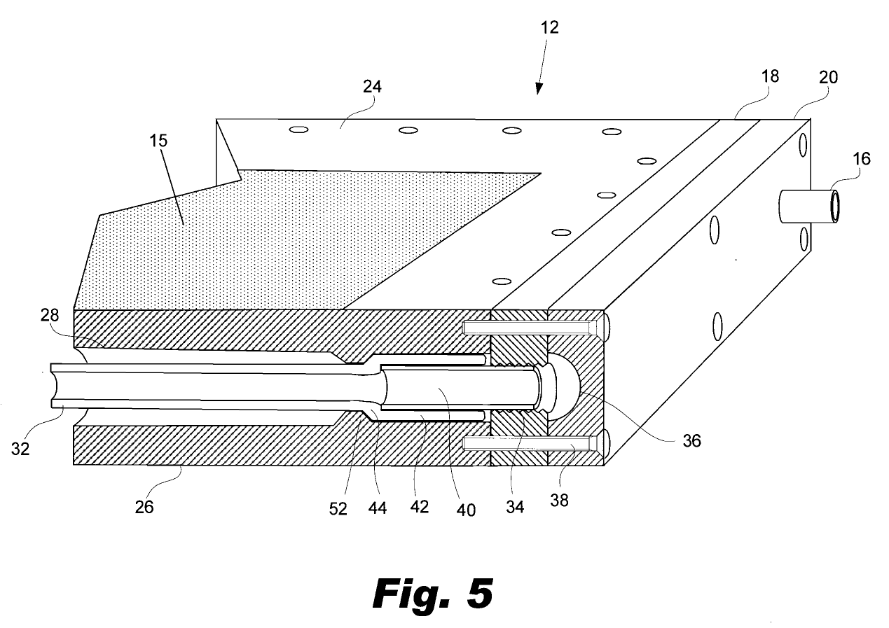

FIG. 5 shows a cross-sectional diagram of one exemplary embodiment of a pin array (12). Specifically, FIG. 5 shows further details regarding an exemplary apparatus for conducting fluid to and from the tubes (32). The pins (14, FIG. 3) are interspersed over the array area (15). The fluid port (16) is attached to a manifold (20). Fluid is introduced or extracted from the pin array (12) through the fluid port (16). The fluid is distributed along the manifold (20) by the manifold channel (36). The manifold channel (36) communicates fluid directly to the first interface plate (18). The first interface plate (18) has a plurality of threaded holes (34) that extend through the first interface plate (18). Attached to the threaded holes (34) is a plurality of nipples (40). The nipples (40) thread into the threaded holes (34) to create a fluid tight seal between the nipples (40) and the interface plate (18). The tube (32) is stretched over the nipple (40), creating a stretched region (42). The top plate (24) and the bottom plate (26) are adapted to create a cavity within which the stretched region (40) of the tube (32) is further compressed by contacting the cavity wall. A first shoulder (52) within the channel (28) then compresses the tube (32) against the protruding end of nipple (40) to further prevent slippage of the tube (32) from the nipple (40). A plurality of screws (38) connects the top plate (24) and the bottom plate (26), as well as the manifold (20) and the interface plate (18) to the bottom plate (26) and the top plate (26). This creates a robust sealing mechanism that assures that the tube (32) is securely fastened to the nipple (40) and provides for the distribution of fluid to each of the tubes (32).

It is understood that the invention is not limited to the specific embodiment disclosed. There are a wide variety of methods of conveying and containing the working fluid that are well known to those of skill in the art. By way of example and not limitation, the nipples (40) could attach to the first interface plate (18) by any suitable means known in the art, such as brazing, press fit, epoxy bonding, etc. It is also possible to separate the system into multiple manifolds that are pressurized independently across the pin array plate. A simple example would have two pages of Braille imaged on the pins. While the locked image of one page is being read then the other page could be reset and re-imaged for continuous reading by the user.

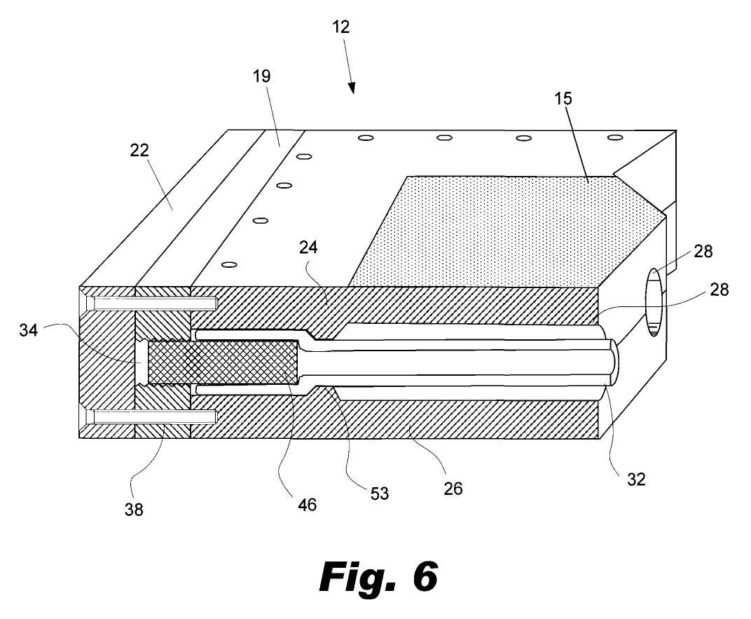

FIG. 6 shows a cross-sectional view of the terminal end of a tube (32). It is understood there are a plurality of tubes (32) within the pin array (12) extending through the pin array and contacting each pin (14, FIG. 3). The pins (14, FIG. 3) are interspersed over the array area (15). In FIG. 6, the tube (32) continues through the channel (28) and encounters a second shoulder (53) and an end plug (46). The tube (32) is stretched over the plug (46) and top plate (24) and the bottom plate (26) clamped over the outer surface of the tube (32) to secure the tube (32) on the plug (46) creating a seal in a mariner similar to that described previously. The plug (46) is attached to the second interface plate (19), which contains a plurality of threaded holes (34) into which the plug (46) is threaded. The end cap (22) attaches to the second interface plate (19) and seals the threaded holes (34). Screws (38) are configured to attach the end cap (22) and the second interface plate (19) to the top plate (24) and the bottom plate (26). In this manner, the plurality of tubes (32) that extend through the channels (32) are terminated so that there is no fluid leakage.

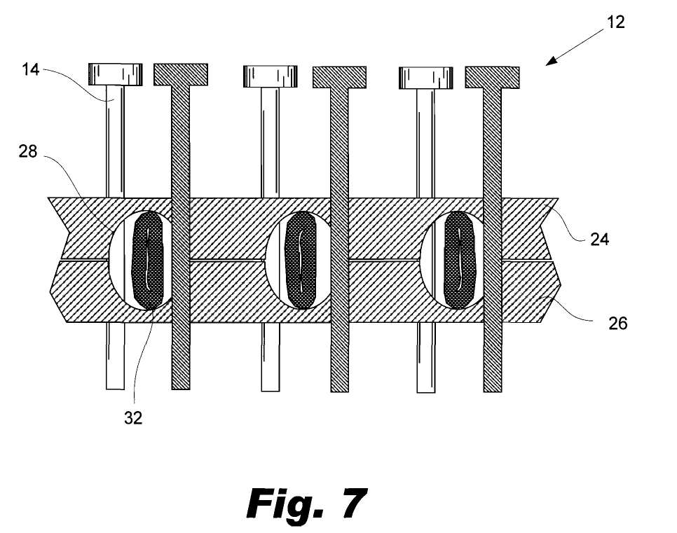

FIG. 7 shows a cross-sectional diagram of a plurality of pins (14) extending through a top plate (24) and a bottom plate (26). The pins (14) may be configured in a variety of geometries and are not limited to the geometry illustrated. By way of example and not limitation, the pins (14) could be simple cylinders with varying terminal geometries or could terminate in an enlarged cross-section on one or both ends of the pin (14). The terminal geometry of the pins serves a variety of purposes including retaining the pins within the plates and providing a more uniform molding surface. The enlarged cross section could be of any geometry, including, but not limited to, cylindrical, rounded, elliptical, spherical, hexagonal, or other polygonal shapes. The pins (14) could also terminate in a variable geometry configured to more closely approximate a continuous three dimensional surface. The optimal size of the terminal geometry depends on a variety of factors such as the desired pin spacing and hole pattern.

The pins (14) could be covered or attached to various materials that improve the characteristics of the pin array. By way of example and not limitation, the ends of the pins (14) on one side of the array could be covered with a thin and flexible membrane that creates a smoother representation of a three dimensional surface, such as a silicon film. While the thin film has the potential to eliminate the imprints of the pin heads in the finished product, it may also limit the amount of fine detail that can be conveyed by the mold. The thin film could be directly attached to the pins or simply placed over the pins. Directly attaching the film to the individual pins could limit the axial motion of the pins and introduce Gaussian bending in the membrane. Factors that could guide the selection of a film material and its dimensions include the resolution of the desired measurement, desired smoothness of the finished product, the amount of detail that is desired to be conveyed by the pin array, thermal resistance, and surface adhesion properties for a thermal molding process.

Further the pins (14) could have additional geometric features along the shaft of the pin (14). By way of example and not limitation, the shafts of the pins (14) could have texture to increase friction, shoulders, grooves, or other geometries. These features could also apply to the plate holes for the pins.

The pins and plates could be made from a variety of plastics, composites, metals, or other suitable material. The optimum materials could vary from application to application. Relevant factors in determining which materials could be used include cost, manufacturability, wear resistance, surface finish, appearance, and other material properties. In one exemplary embodiment, the top plate, bottom plate, and pins are constructed from an appropriate grade of steel. In this embodiment, the steel plates are machined into their final form. The pins are forged and then heat treated in conjunction with the steel plates.

Tubes (32) extend through channels (28) that are formed by grooves within the top plate (24) and bottom plate (26) as described above. In this figure, a partial vacuum has been formed within the flexible tubes (32) and the walls of the tubes (32) have collapsed. In this configuration, there is minimal friction between the tubes (32) and the portions of the pins (14) that protrude into the channel (28). This configuration is advantageous to allow the simultaneous motion of a large number of pins (14) using minimal force, such as when the pin array is reset at the conclusion of a usage cycle.

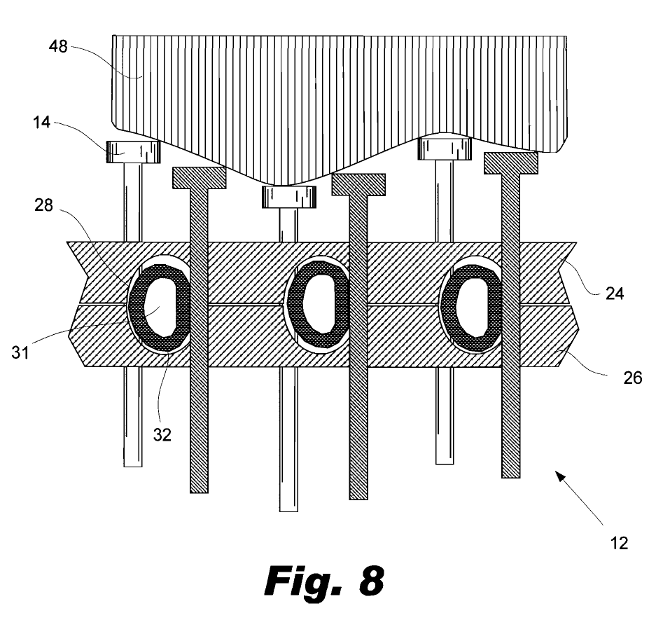

FIG. 8 shows a cross sectional diagram of an object (48) displacing a plurality of pins (14) in a pin array such that the top surfaces of pins (14) create a negative complementary approximation of the surface of the object (48) applied against the pin array. This negative complementary approximation of the surface of the object (48) could form a mold within which material could be cast to create a replica of the object (48). The opposite end of the pins (14) creates a positive approximation of the three dimensional surface of the object (48).

An intermediate amount of locking force is desired when making a surface measurement of the object (48). The intermediate locking force must be sufficient to prevent motion of the pins (14) as a result of accidental acceleration or handling, but not so great that the pins (14) do not respond and conform to the surface of the object (48) or mar the surface of the object (48).

In some embodiments, rather than a physical object, a computer model or Computer Aided Design (CAD) file may be used to represent the surface that the pins (14) are to model. In such a case, an actuator may be used to selectively move or position the individual pins (14) according to the electronic representation of the surface being modeled. In such embodiments, the force on the pins (14) should not require excessive actuation force while the actuator is positioning the pins according to the electronic representation.

When modeling a surface with a pin array, whether a physical surface or an electronic representation, the desired amount of locking force on the pins can be based on many factors, including, but not limited to, the surface hardness of the object being measured, the weight of the object being measured, the number of pins the object covers, pin strength, the actuator force used to position the pins, the amount of actuation energy available, and the like. To achieve the desired amount of locking force, the fluid pressure within the flexible tubes (32) may be infinitely varied.

In this example, fluid pressure within the tubes (32) is approximately equal to the ambient pressure, and the tubes (32) have expanded to take their usual shape except where portions of the pins (14) intrude upon the channel (28). In this configuration, there is moderate force on the pins (14) by the tubes (32), which generates a moderate amount of friction on the pins (14). Because the fluid pressure is uniform within all the tubes (32), the tubes (32) generate substantially uniform friction on all pins (14) in the pin array (12). This protects against inadvertent pin motion as a result of handling, accidental acceleration, or the forces of gravity, but allows the pins (14) to be displaced by contact with the surface of object (48).

Similar principles apply to pin arrays that are moved by actuators. It is understood that the principles disclosed herein are not limited to a specific actuation method and can be readily adapted for use with a variety of actuation methods. By way of example and not limitation, a pin array could be configured with individual actuators for each pin. In other examples, the pin array could include fewer actuators that act on a plurality of pins either simultaneously or serially. These small actuators are moved relative to the pin array to eventually address and position each pin.

For example, if an actuator moves row by row across the pin array as it displaces individual pins, the pin array could be configured to control the pressure within each tube independently. In this manner, a frictional force could be created in the row the actuator was acting on, while higher frictional force could be created in the other rows where the actuator is not. In an actuator that moves in a vector fashion, the pressure within tubes could be adjusted so that the pins were displaced only by the actuator and not by incidental accelerations.

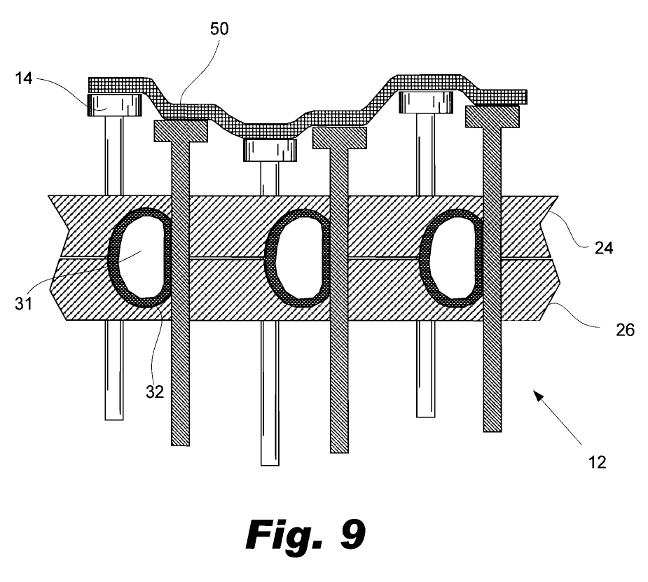

FIG. 9 shows another cross-sectional diagram of a pin array (12). In this figure, the pressure within the tubes (32) has been increased significantly, stretching the tube walls and forcing the tubes (32) to fill the channel (28). The pressure of the tube (32) against the pins (14) is now significant, and the pins (14) are pressed against the opposite sidewall of the holes that pins (14) pass through. This creates significant friction and firmly locks the pins (14) in place. The frictional force between the flexible tube (32), the pins (14) and the hole sidewall can be influenced by a variety of design choices. By way of example and not limitation, the friction may be influenced by the choice of materials, surface roughness, or geometry.

Because each pin (14) is locked against the cylindrical inner wall of the hole it passes through, the locking position of each pin (14) will be substantially repeatable in angle and position. The positional and angular accuracy of the end of the pins can be improved by minimizing the dimensional difference between the pin diameter to the plate hole diameter and by increasing the thickness of the plates that the pins pass through. This repeatability allows for greater precision in replicating a three dimensional surface. With the pins (14) held firmly in place, the pin array (12) can be utilized in a variety of applications that could apply relatively large forces to the pins (14) such as tactile sensing, molding or industrial applications, handling, measurement. or display. FIG. 9 shows the pin array (12) being utilized in a thermoforming operation. In the thermoforming operation, a vacuum is drawn underneath a heated film (50) forcing it against the surface created by the pins (14). The film (50) then cools and hardens creating a representation of the surface of the pin array (12).

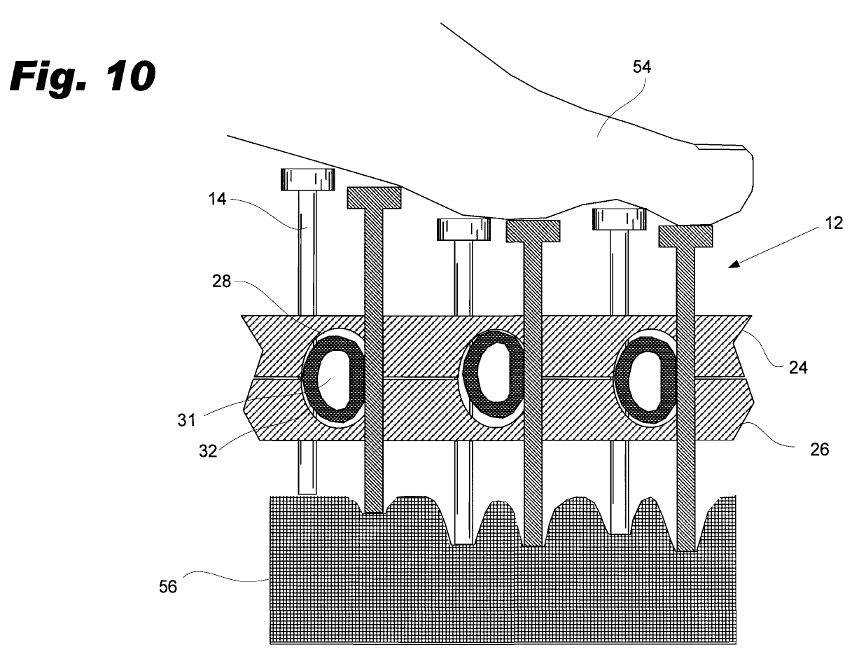

FIG. 10 shows a pin array (12) placed over a compressible mat (56). For clarity, the pins (14) have been shown larger than would typically be used in this application.

In some instances, it is desirable for the resistance of the pins (14) motion to vary as a function of displacement. For instance, when a podiatric physician creates a mold of a patient's foot (54) as a step in the process of creating a podiatric shoe or orthotic insert, the physician wants the pin array to record the shape of the foot, not in a relaxed state, but in a compressed state that approximates the shape of the patient's foot when the patient is walking or standing.

The compressible mat (56) changes the resistance of the pins (14) as a function of displacement. The farther an individual pin is extended into the compressible mat (56), the higher its resistance to further displacement. Thus the pin array (12) conforms to the patient's foot (54) in a compressed condition and obtains a surface measurement that more closely corresponds to the actual profile of the patient's foot (54) when the patient is standing or walking.

A variety of mats can be used to obtain more accurate measurements of the patient's foot (54). By way of example and not limitation, mats of different materials, thicknesses, and geometry could be used separately or in combination to achieve the desired resistance of the pins (14) within the pin array (12). A plurality of springs could also be used to create a compressible mat (54).

After the physician is satisfied that an accurate measurement of the patient's foot (54) has been made, it is important that the locking mechanism be engaged while the patient's foot (54) is still engaged with the pin array (12). This prevents the compressed mat (56) from displacing the pins (14) after the measurement has been made. Once the pin array (12) has been locked, the podiatric shoe or insert can be molded directly from the positive image produced on the bottom of the pin array (12) or adjustments can be made to the pin array surface to effectuate a particular podiatric treatment. This adjustment could be done in a variety of ways, including scanning the surface of the pin array and making adjustments on a computer, then using an actuator to make the changes to the pin array surface prior to molding the podiatric shoe or insert. The locking force exerted by the tubes (32) on the pins (14) can be varied as previously described to facilitate the adjustment and molding process.

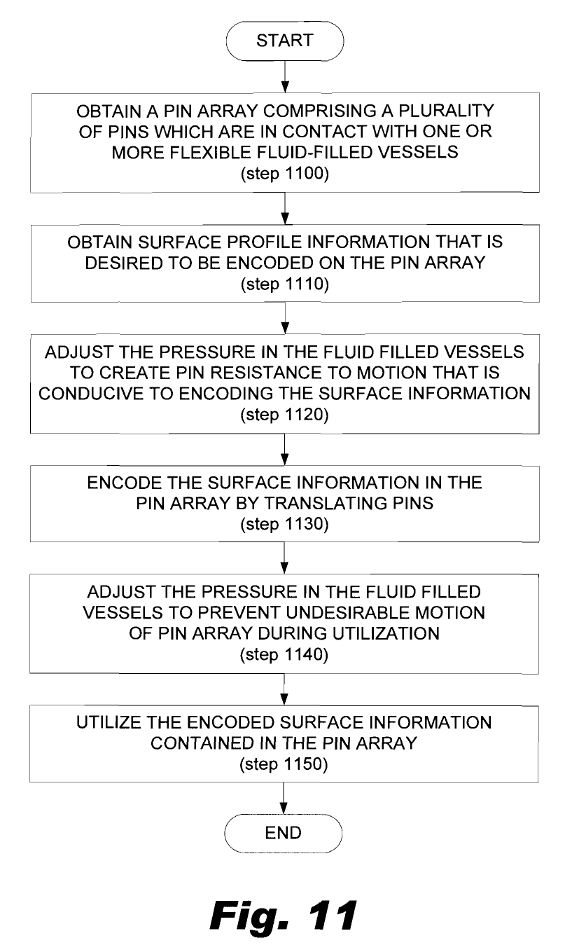

FIG. 11 illustrates a method of utilizing a pin array locking mechanism. Initially (step 1100), a pin array comprising a number of pins which are in contact with one or more flexible fluid-filled vessels is obtained. The pin array could have a variety of geometries and configurations as described above. Next (step 1110), surface profile information is obtained. The surface information can be obtained in a variety of methods. By way of example and not limitation, the surface information could be obtained by generating an electronic file representing a surface profile, acquiring a physical object with a surface profile, measuring the surface profile of a three dimensional object, or making desirable alterations to a measured surface profile.

After obtaining a surface profile, the pressure in the fluid-filled vessels is adjusted to create pin resistance that is conducive to encoding the surface information in the pin array (step 1120). The surface information is encoded into the pin array by translating the pins with respect to the fluid filled vessels. As described above, an intermediate amount of force is typically desired when encoding surface information into the pin array by translating the pins. The pressure within the flexible vessels can be adjusted in a variety of ways to facilitate encoding information into the pin array. The method and sequence of changing the pressure within the flexible vessels varies according to a variety of factors described above. By way of example and not limitation, the pressure within the flexible vessel may be varied such that all the pins within the array have a substantially uniform resistance to translation. In another exemplary embodiment, the pressure may be varied such that the pins which are being actuated have a lower resistance to motion, while those pins which are not being actuated have a higher resistance to motion.

The surface information is then encoded in the pin array by translating the pins (step 1130). By way of example and not limitation, the pins may be translated by bringing an object into contact with the pin array, using an actuator that moves the pins en mass, using a sequential or vector actuator, or by using individual actuators which move single pins.

After the surface information is encoded, the pressure in the fluid-filled vessels is adjusted to prevent the undesirable motion of the pin array during utilization (step 1140). The amount of pressure within the tubes that is required to prevent undesirable motion depends on a variety of factors, including, handling, vibration, and the magnitude of external forces that will be exerted on the pins during utilization. In some cases, it could be desirable to make adjustments to the surface profile after it has been encoded, which would require that some portion of the pins have an intermediate amount of resistance to translation such that the pins could be moved to accommodate the desired adjustment.

With the pins in the desired positions and the pressure adjusted to prevent undesirable motion, the pin array is configured to be utilized (step 1150). As described above, the pin array could be utilized in a variety of methods or systems including, but not limited to, creating a three dimensional surface to communicate information for the sight impaired or forming a reconfigurable mold.

As can be seen from the preceding description, the present invention creates an inexpensive pin array locking mechanism that is configured to exert an adjustable amount of locking force. Further, because of the uniform fluid pressure within the locking mechanism, a substantially uniform locking force will be exerted on each pin in the array. Unlike other pin array locking mechanisms, the locking force is not substantially affected by wear.

The preceding description has been presented only to illustrate and describe embodiments and examples of the principles described. This description is not intended to be exhaustive or to limit these principles to any precise form disclosed. Many modifications and variations are possible in light of the above teaching.

1. A pin array comprising:
a plurality of pins arranged in an array; and
one or more flexible tubes in contact with each of said pins such that, when said one or more flexible tubes are internally pressurized, each said flexible tube enlarges to apply pressure to sides of said pins to prevent further movement of said pins.

2. The pin array of claim 1, further comprising:
a substrate having holes therethrough, each pin in said array being disposed in a hole through said substrate; and
a plurality of channels through said substrate that correspond to said array of pins such that each said hole containing a pin intersects and communicates with a said channel;
wherein said flexible tubes are disposed in said channels and in contact with each of said pins in said holes.

3. The pin array of claim 2, where said substrate comprises a top plate and a bottom plate that sandwich said flexible tubes in said channels.

4. The pin array of claim 1, further comprising a manifold for delivering pressurized fluid into said flexible tubes or removing fluid from said flexible tubes.

5. The pin array of claim 4, wherein said manifold is configured to selectively create a vacuum or a positive pressure in each of said flexible tubes using said fluid.

6. The pin array of claim 4, wherein one end of each of said flexible tubes is disposed over a nipple of said manifold and clamped to said nipple.

7. The pin array of claim 5, wherein an opposite end of each of said flexible tubes is disposed over and clamped to a plug.

8. The pin array of claim 1, further comprising a compressible mat disposed on one side of said array of pins such that displacement of a pin into said mat requires an increasing force.

9. A method of locking a pin array that includes a plurality of pins arranged in an array; and one or more elastic vessels in contact with each of said pins, said method comprising controlling a pressure of a fluid in said elastic vessels to selectively allow or prevent movement of said pins with respect to said elastic vessels.

10. The method of claim 9, wherein said elastic vessels comprise one or more tubes running along a row or column of pins, said controlling a pressure further comprising controlling said pressure of a fluid in said tube to selectively allow or prevent movement of said pins.

11. The method of claim 10, further comprising independently controlling the pressure in each said tube.

12. The method of claim 10, further comprising a tube running between adjacent rows or columns of pins and physically contacting the pins in both of said adjacent rows or columns.

13. The method of claim 9, further comprising disposing a compressible mat on one side of said array of pins such that displacement of a pin into said mat requires an increasing force.

14. The method of claim 9 further comprising:
positioning said pins in a desired configuration; and
pressurizing said elastic vessels to prevent further movement of said pins.

15. The method of claim 14, further comprising using an actuator driven by an electronic model of said desired configuration to position said pins.

16. The method of claim 14, further comprising vacuum sealing a film over said pins in said desired configuration.

17. The method of claim 14, wherein said desired configuration comprises a shape for an orthotic.

18. The method of claim 14, wherein said desired configuration comprises a message in Braille.

19. A pin array comprising:
a plurality of pins arranged in an array;
one or more flexible vessels in contact with said pins; and
means for controlling a pressure in said one or more flexible vessels causing said flexible vessels to selectively apply pressure to said pins to allow or prevent movement of said pins with respect to said one or more flexible vessels.
